(19) United States
(12) Patent Application Publication
(10) Pub. No.: US 2002/0014570 A1
(43) Pub. Date: Feb. 7, 2002

(54) Ground anchor

(75) Inventor: Rudolf Jenny, Mollis (CH)

Correspondence Address: Norman P. Soloway,, HAYES, SOLOWAY, HENNESSEY, GROSSMAN & HAGE, P.C., 130 W. Cushing Street, Tucson, AZ, 85701, US

(73) Assignee: Plica Werkzeugfabrik AG

(21) Appl. No.: 09/911,071

(22) Filed: Jul. 23, 2001

(30) Foreign Application Priority Data
Jul. 28, 2000 (DE) 200 13 087.0

(51) Int. Cl. F16M 13/00

(52) U.S. Cl. 248/545

(57) ABSTRACT

A ground anchor comprises a threaded portion, a head portion and a spreading means.

The invention relates to a ground anchor having a threaded portion and a head portion.

### BACKGROUND OF THE INVENTION

Ground anchors of this type are known in various constructions. They are threaded into the soil with their threaded portion in order to fix objects by connecting them with the head portion of the ground anchor.

The object of the invention is to improve the known ground anchors such that the pull-out force or the holding force of the ground anchor in the soil is improved.

### BRIEF DESCRIPTION OF THE INVENTION

According to the invention, a ground anchor having a threaded portion and a head portion is provided with an expanding means. The expanding means is activated after threading the ground anchor into the soil, in order to increase the holding force of the ground anchor in the soil.

According to a preferred embodiment of the invention, the spreading means is formed by two spreading anchors which are accommodated in the interior of the threaded portion of the ground anchor and are able to project laterally by means of two slots Since the spreading anchors are forced into the soil which is already compressed by means of the spreaded portion, the holding force resulting from a compression of the soil in the vicinity of the ground anchor is improved. In order to activate the spreading anchors, a straining screw is provided on which a drive nut connected to the spreading anchors is arranged Upon tightening of the straining screw, the drive nut is forced towards the tip of the threaded portion. This results in the spreading anchors being pressed against ramps provided at the end of the respective slot, so that the spreading anchor is extended outwardly. As the spreading anchors open from the bottom towards the top and in the other direction are closed from the top towards the bottom, it is possible to retract the spreading anchors from the threaded portion and to remove them from the ground anchor after use. The ground anchor can be threaded from the soil either after retracting the spreading anchors into a retracted position or after removing the spreading anchors from the ground anchor.

According to another preferred embodiment of the invention, the spreading means is formed by a plurality of webs of the material of the threaded portion. The material webs are formed by providing a plurality of slots in the threaded portion. In the interior of the threaded portion, a straining screw is provided which is screwed into a forward portion of the threaded portion. When the straining screw is tightened, the ground anchor is compressed in as manner comparable to a cavity plug, resulting in the webs being bulged outwardly. This also results in an increased holding force in the compressed soil in the vicinity of the ground anchor.

Advantageous details of the invention are defined in the subclaims.

### BRIEF DESCRIPTION OF THE DRAWINGS

The invention is hereinafter described with reference to preferred embodiments which are shown in the accompanying drawings

FIG. 1 shows a ground anchor according to a first embodiment of the invention in a side view.

FIG. 2 shows the ground anchor of FIG. 1 in a first position in a sectional view along plane S of FIG. 1.

FIG. 3 shows, in a view corresponding to that of FIG. 2, the ground anchor in a second position.

FIG. 4 shows, in a view corresponding to that of FIG. 2, the ground anchor in a third position.

FIG. 5 shows a ground anchor according to a second embodiment of the invention in a side view.

FIG. 6 shows the ground anchor of FIG. 5 in a first position in a sectional view along plane S of FIG. 5.

FIG. 7 shows, in a view corresponding to that of FIG. 6, the ground anchor of FIG. 6 in a second position

FIG. 8 shows a ground anchor according to a third embodiment in a side view.

FIG. 9 shows a sectional view along plane IX-IX of FIG. 8.

FIG. 10 shows a ground anchor according to a fourth embodiment of the invention in a side view.

FIG. 11 shows a sectional view along plane XI-XI of FIG. 10.

### DETAILED DESCRIPTION OF THE INVENTION

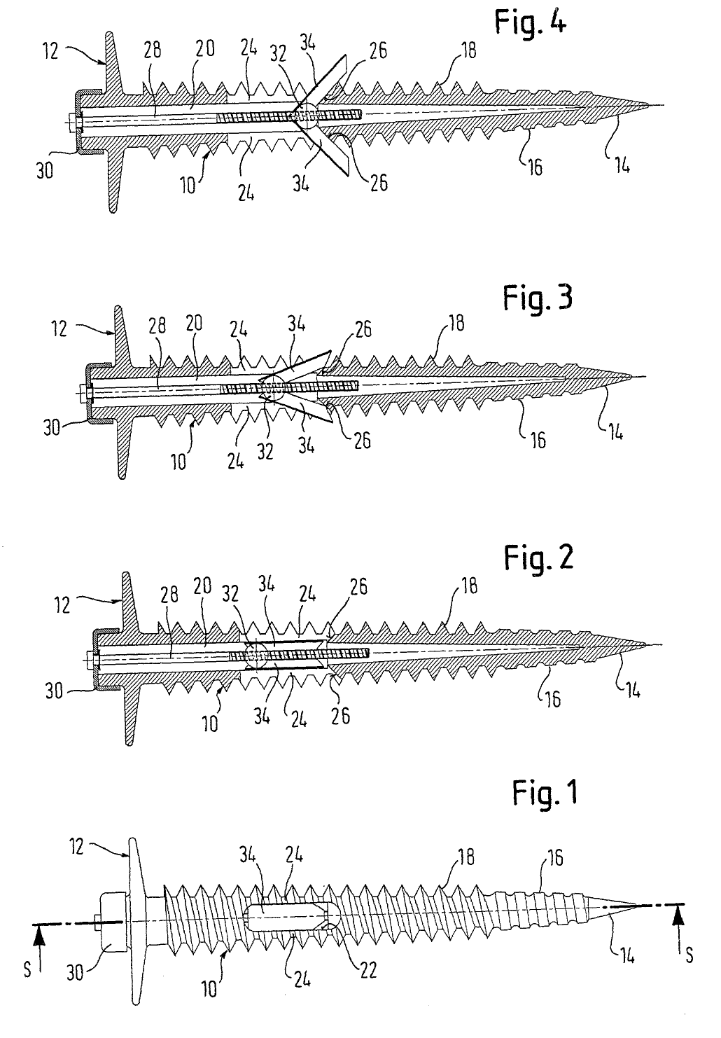

FIGS. 1 to 4 show a ground anchor according to a first embodiment. The ground anchor comprises a threaded portion 10 and a head portion 12. The threaded portion 10 is adapted to be threaded into the soil until the head portion 12 of the ground anchor contacts the surface of the soil. For this operation, a handle not shown in the drawings can be used which engages at a suitable profile of the head portion, for example at a hexagon profile.

The threaded portion comprises a tip 14 at which no thread is provided, and adjacent thereto a portion 16 in which a thread with flattened crests is provided. Portion 16 is followed by a thread 18 having an acute angle between the flank faces of the thread.

The threaded portion 10 is formed hollow so that an interior space 20 is provided. Further, two slots 22 are provided which are arranged diametrically, whereby two diametrically arranged webs 24 are formed in the threaded portion At each side of each slot 22, which is closer to the tip of the threaded portion, a ramp 26 is formed. The function of the ramps will be explained later.

A straining screw 28 is arranged in the interior space 20 of the threaded portion, the screw head of the straining screw being accessible at the head portion 12 of the ground anchor. At the head portion, an abutment 30 is provided for the straining screw 28. A drive nut 22 is arranged at the straining screw 28, with which two spreading anchors 34 are pivotally connected FIGS. 1 and 2 show a rest position in which both spreading anchors 34 are arranged in the interior space 20. They accordingly do not project outwardly through the slots 22 When the straining screw 28 is turned so as to advance the drive nut towards the tip 14 of the ground anchor, the spreading anchors 34 are forced with their tip against the ramps 26 such that they are spreaded outwardly. This is shown in FIG. 3. By turning the straining screw further, the spreading anchors can be brought into their spreading position shown in FIG. 4, in which they are forced into the soil in the vicinity of the ground anchor and increase the holding force of the ground anchor.

By turning the straining screw 28 in the opposite direction, the spreading anchors 34 can be retracted into the rest position shown in FIG. 2, which allows to easily remove the ground anchor from the soil.

The spreading anchors 34 and the drive nut 32 are formed such that they can be inserted into the interior space 20 of the threaded portion from the side of the head portion 12.

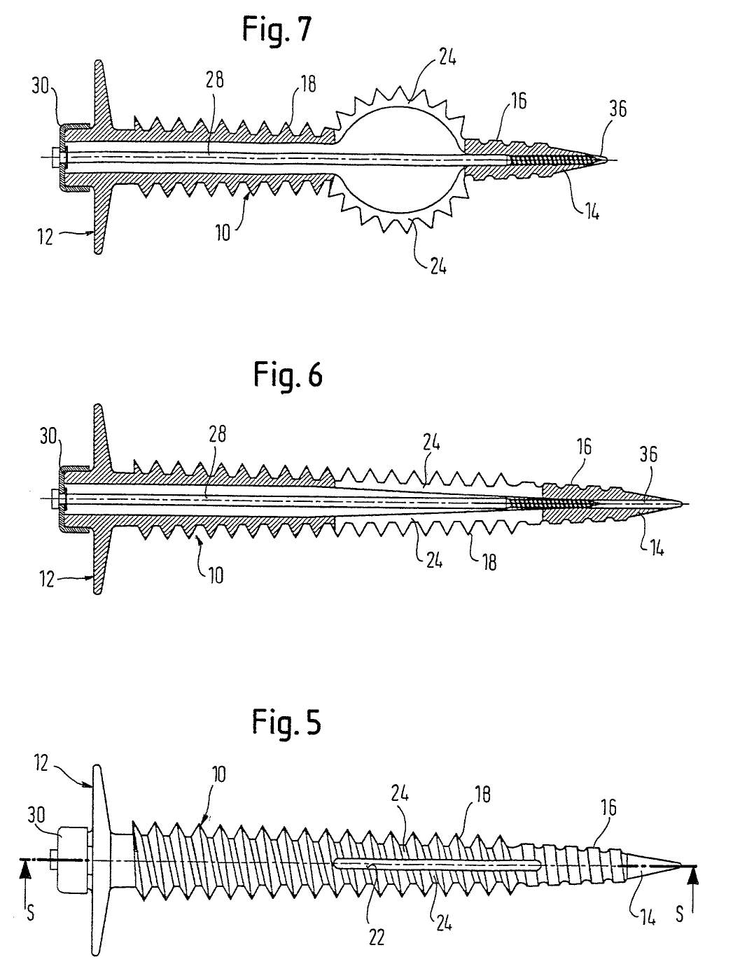

FIGS. 5 to 7 show a ground anchor according to a second embodiment. The same reference numerals are used for those components which are known from the first embodiment, and reference is made to the explanations given above.

In the second embodiment as well, two slots 22 are provided by which two diametrically arranged material webs 24 are formed. Unlike the first embodiment, the slots are very narrow in the second embodiment. If desired, more than two slots could be used as well.

In the second embodiment, the straining screw 28 is threaded into a bore 36 which is formed in the forward portion of the threaded portion 10 forward of the slots 22. At the rearward end, the straining screw 28 is held in abutment 30 at the head portion. By tightening the straining screw 28, tip 14 of the threaded portion is retracted towards the head portion, whereby webs 24 bulge outwardly. This is shown in FIG. 7. Bulging webs 24 increase the holding force in the soil.

In the second embodiment, a screw adapted to particle boards can be used as straining screw.

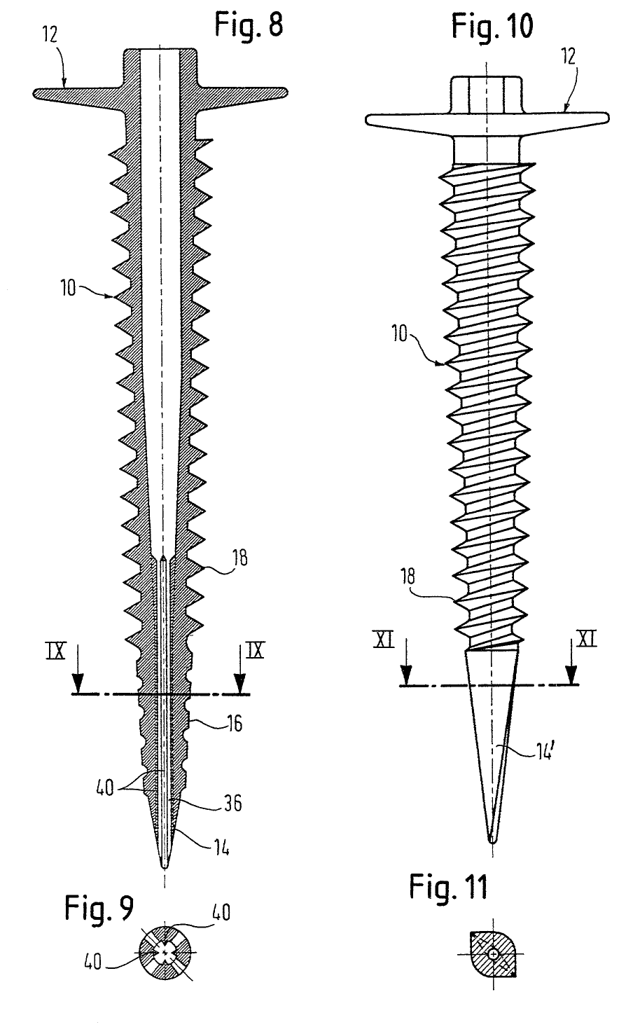

A ground anchor according to a third embodiment is shown in FIGS. 8 and 9 This embodiment largely corresponds to the second embodiment However, in the interior of bore 36, four fins 40 are provided which extend in the longitudinal direction. Each fin 40 is very narrow so that it can be easily deformed by the straining screw. However, each fin provides sufficient material in order to increase the holding force of the straining screws in bore 36.

FIGS. 10 and 11 show a ground anchor according to a fourth embodiment. This embodiment differs from the previous embodiments in that tip 14′ extends up to thread 18 having an acute angle between its flank faces In other words, no intermediate portion with flattened crests is provided. Tip 14′ has the cross section shown in FIG. 11, this cross section being comparable to a square of which two opposite edges are rounded. This cross section results in a particularly good compression of the soil during insertion of the ground anchor.

The ground anchor described above can be used in all types of soil and sand for attaching trees, bushes, foils, awnings, houses, tents and other objects in horticulture, landscape-gardening, forresting, etc.

A material particularly suitable for the ground anchor is plastics.

According to a preferred embodiment, it is provided that the ground anchor is formed by a material which is biologically degradable within a time period of one to five years. Such biologically degradable material can be obtained by adding suitable additives to a matrix material, typically polyethylene or polypropylene. In addition, wood fibers can be added.

1. Ground anchor having a threaded portion, a head portion and a spreading means.

2. The ground anchor of claim 1, wherein said threaded portion is formed hollow and is provided with a plurality of slots.

3. The ground anchor of claim 2, wherein two of said slots are provided.

4. The ground anchor of claim 2, wherein a straining screw is arranged in said threaded portion.

5. The ground anchor of claim 4, wherein an abutment is provided for said straining screw, said abutment being arranged at said head portion.

6. The ground anchor of claim 5, wherein said straining screw is threaded into a forward portion of said threaded portion, whereby said threaded portion is able to be spreaded outwardly in a region of said slots by tightening said straining screw.

7. The ground anchor of claim 6, wherein a bore is provided in said forward portion of said threaded portion, said straining screw being threaded into said bore and said bore being provided with a plurality of fins extending in a longitudinal direction

8. The ground anchor of claim 5, wherein a drive nut is arranged at said straining screw, two spreading anchors being provided which are connected to said drive nut such that they can be transferred from a rest position in which they are arranged within said threaded portion, into a spreaded position in which they project outwardly through said slots.

9. The ground anchor of claim 8, wherein said drive nut is moved away from said head portion for spreading said spreading anchors.

10. The ground anchor of claim 8, wherein each of said slots has an end which is a forward end, each of said forward ends being provided with a ramp cooperating with one of said spreading anchors.

11. The ground anchor of claim 1, wherein said threaded portion is provided with a tip having no threads.

12. The ground anchor of claim 11, wherein said tip having no threads has a cross section formed by a square of which two opposite ends are rounded.

13. The ground anchor of claim 11, wherein a portion having a thread with flattened crests is provided adjacent said tip having no threads.

14. The ground anchor of claim 1, being made from a biologically degradable material.

15. The ground anchor of claim 14, wherein said biologically degradable material degrades within a time period of one to five years.

16. The ground anchor of claim 14, wherein said material comprises wood fibers
